(19) United States
(12) Patent Application Publication
(10) Pub. No.: US 2026/0196379 A1
(43) Pub. Date: Jul. 9, 2026

(54) WIRING MEMBER AND MANUFACTURING METHOD FOR WIRING MEMBER

(71) Applicant: SUMITOMO WIRING SYSTEMS, LTD., Mie (JP)

(72) Inventors: Lin WEI, Mie (JP); Toshinari KOBAYASHI, Mie (JP); Moriyuki SHIMIZU, Mie (JP)

(21) Appl. No.: 19/440,948

(22) Filed: Jan. 6, 2026

(30) Foreign Application Priority Data
Jan. 8, 2025 (JP) 2025-002794

(51) Int. Cl. H01B 7/00; H01B 13/012; B60R 16/02

(52) U.S. Cl. CPC H01B 7/0045; H01B 13/01209; B60R 16/0215

(57) ABSTRACT

A wiring member includes: a plurality of wirings including a first wiring and a second wiring; and a plurality of sheaths covering at least part of the plurality of wirings. The second wiring extends alongside the first wiring in a first segment and branches from the first wiring at a first branch portion. The plurality of sheaths include a first sheath covering the first wiring and the second wiring in the first segment, and a second sheath covering the second wiring in a second segment after the first branch portion. The first sheath and the second sheath are coating members of a same type that are formed of a same material.

### CROSS-REFERENCE TO RELATED APPLICATIONS

This application is based on and claims priority from Japanese Patent Application No. 2025-002794, filed on January 8, 2025, with the Japan Patent Office, the disclosure of which is incorporated herein in its entirety by reference.

### TECHNICAL FIELD

The present disclosure relates to a wiring member and a manufacturing method for a wiring member.

### BACKGROUND

JP 2020-191294 A discloses a wiring member that includes a first resin molded portion provided at a first branch position and a second resin molded portion provided at a second branch position. In the wiring member, the part of the electric wires between the first branch position and the second branch position is covered with a rubber hose or the like.

### SUMMARY

Cost reduction of wiring members is desired.

The present disclosure accordingly has an object of providing a technique that can reduce the cost of wiring members.

A wiring member according to the present disclosure includes: a plurality of wirings including a first wiring and a second wiring; and a plurality of sheaths covering at least part of the plurality of wirings, wherein the second wiring extends alongside the first wiring in a first segment and branches from the first wiring at a first branch portion, the plurality of sheaths include a first sheath covering the first wiring and the second wiring in the first segment, and a second sheath covering the second wiring in a second segment after the first branch portion, and the first sheath and the second sheath are coating members of a same type that are formed of a same material.

According to the present disclosure, it is possible to reduce the cost of wiring members.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a wiring member according to Embodiment 1.

FIG. 2 is a plan view showing the wiring member according to Embodiment 1.

FIG. 3 is a sectional view taken along line III-III in FIG. 1.

FIG. 4 is an end view taken along line IV-IV in FIG. 2.

FIG. 5 is an end view taken along line V-V in FIG. 2.

FIG. 6 is an end view showing a modification of a trace left by pulling out a first wiring.

FIG. 7 is a plan view showing how the wiring member is manufactured.

FIG. 8 is a plan view showing how the wiring member is manufactured.

FIG. 9 is a plan view showing how the wiring member is manufactured.

FIG. 10 is a plan view showing how the wiring member is manufactured.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

A wiring member according to the present disclosure is as follows.

(1) A wiring member includes: a plurality of wirings including a first wiring and a second wiring; and a plurality of sheaths covering at least part of the plurality of wirings, wherein the second wiring extends alongside the first wiring in a first segment and branches from the first wiring at a first branch portion, the plurality of sheaths include a first sheath covering the first wiring and the second wiring in the first segment, and a second sheath covering the second wiring in a second segment after the first branch portion, and the first sheath and the second sheath are coating members of a same type that are formed of a same material.

With the wiring member according to (1), a part of an elongated sheath including the first sheath and the second sheath can be used as the first sheath and another part of the elongated sheath can be used as the second sheath. This makes it unnecessary to provide another member such as a rubber hose instead of the sheath, thereby achieving cost reduction.

(2) In the wiring member according to (1), the plurality of wirings may include a third wiring extending alongside the first wiring and the second wiring inside the first sheath in the first segment, and the second wiring and the third wiring may extend alongside each other inside the second sheath in the second segment and branch at a second branch portion that extends out from an end of the second sheath. This allows the second sheath to function as a protective material for the wirings between the first branch portion and the second branch portion.

(3) The wiring member according to (1) or (2) may include: a first resin molded portion covering the first wiring, the second wiring, the third wiring, the first sheath, and the second sheath in the first branch portion; and a second resin molded portion covering the second wiring, the third wiring, and the second sheath in the second branch portion. Since the materials of the first sheath and the second sheath are the same, it is easy to select compatible materials for the first resin molded portion, the first sheath, and the second sheath. Moreover, by using the same material for the second resin molded portion as for the first resin molded portion, it is easy to select compatible materials for the second resin molded portion and the second sheath.

(4) In the wiring member according to (3), the plurality of sheaths, the first resin molded portion, and the second resin molded portion may be formed of a urethane-based material. This enhances the adhesion between the resin molded portions and the sheaths, and enhances the watertightness between the resin molded portions and the sheaths.

(5) The wiring member according to (1) may include a resin molded portion covering the first wiring, the second wiring, the first sheath, and the second sheath in the first branch portion. Since the materials of the first sheath and the second sheath are the same, it is easy to select compatible materials for the first resin molded portion, the first sheath, and the second sheath.

(6) In the wiring member according to any one of (1) to (5), the second sheath may have a trace left by pulling out the first wiring. This makes it easy to determine that the original single sheath has been divided into the first sheath and the second sheath.

(7) A manufacturing method for a wiring member according to the present disclosure includes: a step of preparing a cable that includes a plurality of wirings including a first wiring and a second wiring and a sheath covering the plurality of wirings; a step of cutting the sheath to divide the sheath into a first sheath and a second sheath at an intermediate portion of the cable; and a step of pulling the first wiring out of the second sheath to branch the first wiring from the second wiring between the first sheath and the second sheath.

With the manufacturing method for a wiring member according to (7), a part of the sheath of the original cable can be used as the first sheath and another part of the sheath can be used as the second sheath. This makes it unnecessary to provide another member such as a rubber hose instead of the second sheath, thereby achieving cost reduction.

### Details of Embodiments of the Present Disclosure

Specific examples of a wiring member according to the present disclosure will be described below with reference to the drawings. The present disclosure is not limited to these examples, but is defined by the claims and intended to include all modifications within the meaning and scope equivalent to the claims.

### Embodiment 1

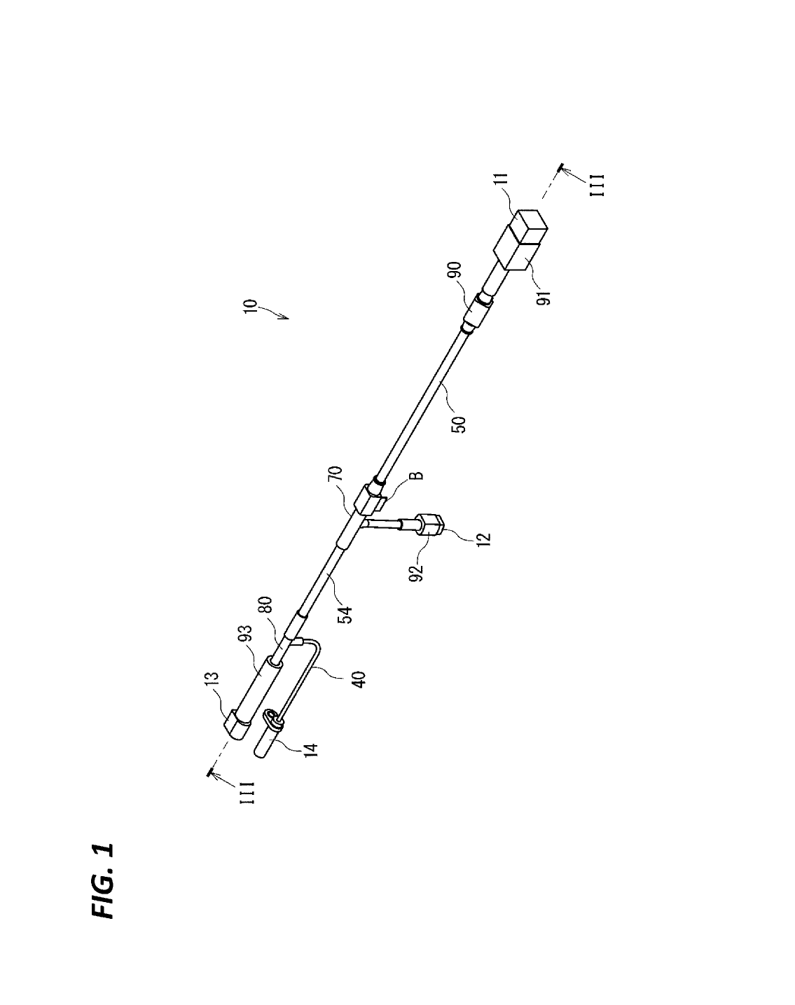

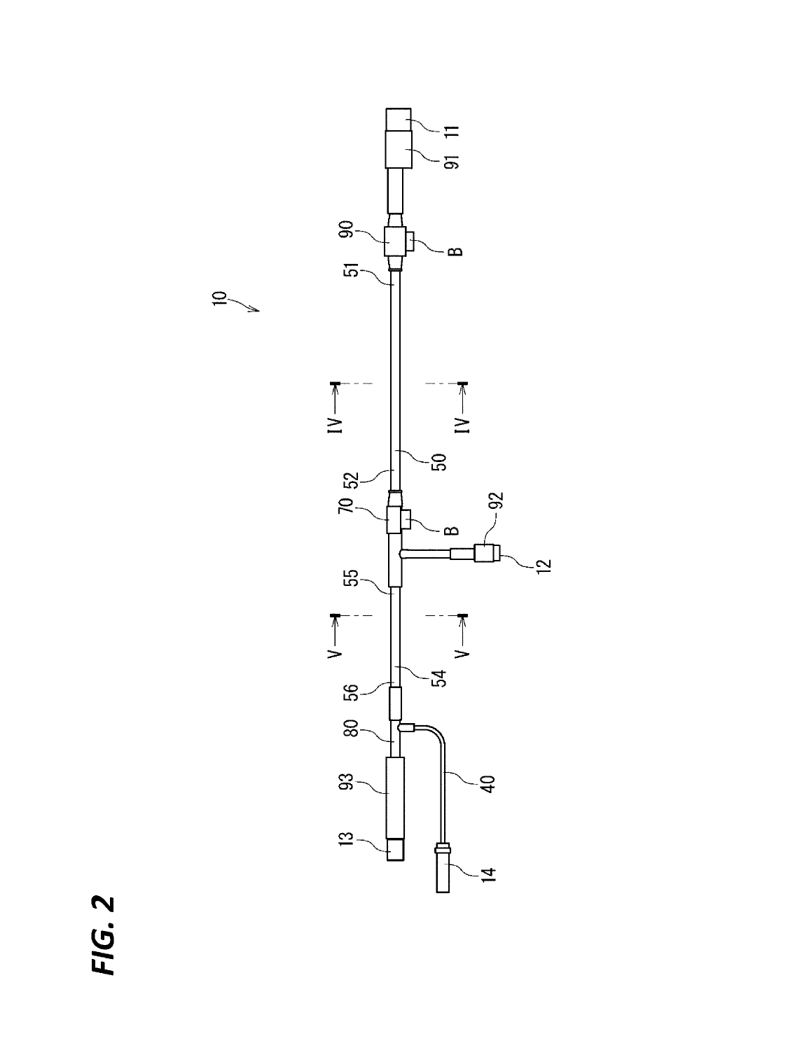

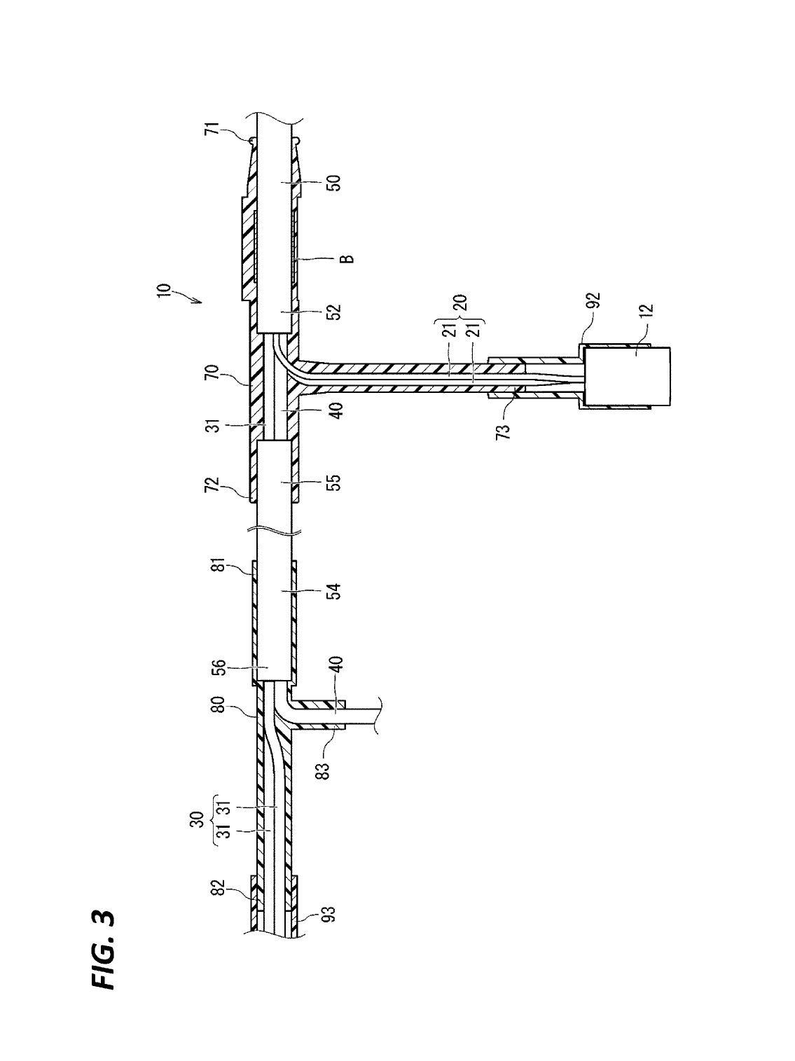

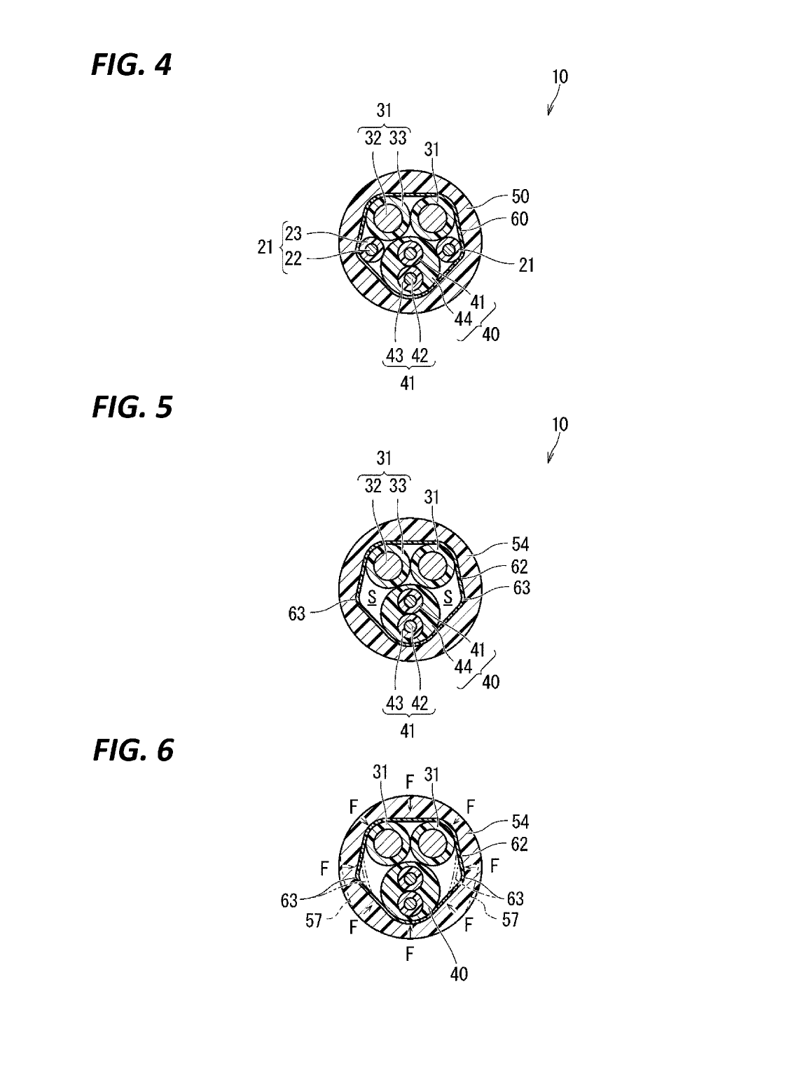

A wiring member 10 according to Embodiment 1 will be described below. FIG. 1 is a perspective view showing the wiring member 10 according to Embodiment 1. FIG. 2 is a plan view showing the wiring member 10 according to Embodiment 1. FIG. 3 is an end view taken along line III-III in FIG. 1. FIG. 4 is an end view taken along line IV-IV in FIG. 2. FIG. 5 is an end view taken along line V-V in FIG. 2.

The wiring member 10 includes a plurality of wirings and a plurality of sheaths. The wiring member 10 is arranged in a vehicle suspension, for example. The wiring member 10 connects a vehicle body-side device and a suspension-side device.

The plurality of wirings include a first wiring 20 and a second wiring 30. Here, the plurality of wirings also include a third wiring 40. The first wiring 20, the second wiring 30, and the third wiring 40 extend alongside each other in a first segment. The second wiring 30 and the third wiring 40 branch from the first wiring 20 at a first branch portion. The second wiring 30 and the third wiring 40 extend alongside each other in a second segment. The second wiring 30 and the third wiring 40 branch at a second branch portion.

The plurality of sheaths cover at least part of the plurality of wirings. The plurality of sheaths include a first sheath 50 and a second sheath 54. The first sheath 50 covers the first wiring 20, the second wiring 30, and the third wiring 40 in the first segment. The second sheath 54 covers the second wiring 30 and the third wiring 40 in the second segment.

The first wiring 20 includes a plurality (a pair in this example) of first coated electric wires 21. Each of the first coated electric wires 21 includes a first core wire 22 and a first insulating coating 23 covering the first core wire 22.

The second wiring 30 includes a plurality (a pair in this example) of second coated electric wires 31. Each of the second coated electric wires 31 includes a second core wire 32 and a second insulating coating 33 covering the second core wire 32.

The third wiring 40 includes a plurality (a pair in this example) of third coated electric wires 41. Each of the third coated electric wires 41 includes a third core wire 42 and a third insulating coating 43 covering the third core wire 42.

Each of the core wires 22, 32, and 42 is composed of one or more strands. The strands are, for example, made of a conductor such as copper, a copper alloy, aluminum, or an aluminum alloy. The plurality of strands may be twisted.

Each of the insulating coatings 23, 33, and 43 is formed by, for example, extruding resin around the corresponding one of the core wires 22, 32, and 42. The type of resin is not particularly limited, and examples thereof include polyvinyl chloride, polyolefin, and polyurethane.

The third wiring 40 includes a cable coating 44 covering the plurality of third coated electric wires 41. The cable coating 44 is formed, for example, by extruding resin around the plurality of third coated electric wires 41. The type of resin is not particularly limited, and examples thereof include polyvinyl chloride, polyolefin, and polyurethane. As a result of the cable coating 44 being provided, the third wiring 40 is formed as one cable. Hereinafter, the cable forming the third wiring 40 is also referred to as "cable 40" using the same reference numeral as the third wiring 40.

The first wiring 20 and the second wiring 30 have no cable coating 44. Therefore, in the case where the first sheath 50 is stripped, five wire materials, namely, two first coated electric wires 21, two second coated electric wires 31, and one cable 40, are observed externally.

Each first coated electric wire 21 is thinner than each second coated electric wire 31. Each third coated electric wire 41 has the same thickness as each first coated electric wire 21. The cable 40 is thicker than each first coated electric wire 21. The cable 40 is thicker than each second coated electric wire 31.

The two second coated electric wires 31 and the one cable 40 are arranged in a triangular shape in a cross-sectional view so as to be in contact with each other. One of the first coated electric wires 21 is arranged so as to be in contact with one of the second coated electric wires 31 and the cable 40. The other of the first coated electric wires 21 is arranged so as to be in contact with the other of the second coated electric wires 31 and the cable 40. The five wire materials are arranged in a pentagonal shape in a cross-sectional view.

In each of the first coated electric wires 21, the second coated electric wires 31, and the cable 40, the end on the first connector 11 side is referred to as one end, and the end on the opposite side is referred to as the other end. In the first sheath 50, the end portion on the first connector 11 side is referred to as one end portion 51, and the end portion on the opposite side is referred to as the other end portion 52. In the second sheath 54, the end portion on the first sheath 50 side is referred to as one end portion 55, and the end portion on the opposite side is referred to as the other end portion 56.

The length from the other end of the first coated electric wires 21 to the other end portion 52 of the first sheath 50 may be shorter than the length from the other end of the second coated electric wires 31 to the other end portion 52 of the first sheath 50 and the length from the other end of the cable 40 to the other end portion 52 of the first sheath 50. The length from the other end of the first coated electric wires 21 to the other end portion 52 of the first sheath 50 may be shorter than the length from the other end portion 56 of the second sheath 54 to the other end portion 52 of the first sheath 50. The length from the other end of the first coated electric wires 21 to the other end portion 52 of the first sheath 50 may be shorter than the length from the one end portion 55 to the other end portion 56 of the second sheath 54.

The wiring member 10 includes interposed members 60 and 62. The interposed member 60 is interposed between the first sheath 50 and the plurality of wirings. The interposed member 62 is interposed between the second sheath 54 and the plurality of wirings. For example, the interposed members 60 and 62 are sheet-like members that are longitudinally attached to or helically wound around the plurality of wirings. The interposed members 60 and 62 are also referred to as wrapping tape, for example. The interposed members 60 and 62 may be non-woven fabric, paper, solid resin sheets, or foamed sheets.

There is an empty space between the interposed members 60 and 62 and the wirings. The parts of the interposed member 60 that are in contact with the first coated electric wires 21, the second coated electric wires 31, and the cable 40 have curved shapes corresponding to the outer surfaces of the first coated electric wires 21, the second coated electric wires 31, and the cable 40. The parts of the interposed member 60 that are not in contact with the first coated electric wires 21, the second coated electric wires 31, and the cable 40 have linear shapes. The interposed member 60 is formed in a pentagonal shape in a cross-sectional view.

The wiring member 10 may include a second interposed member that fills the space between each of the interposed members 60 and 62 and the wirings. Such a second interposed member may be a fibrous member extending in the longitudinal direction of the wiring member 10. In the case where the wiring member 10 includes the second interposed member, the interposed members 60 and 62 may have a near-circular shape in a cross-sectional view.

The first sheath 50 and the second sheath 54 are coating (i.e., covering) members of the same type that are formed of the same material. The first sheath 50 and the second sheath 54 are originally a single sheath. The original sheath is cut at an intermediate portion to be divided into the first sheath 50 and the second sheath 54. Thus, "coating members of the same type" mean those that can be presumed to be the same coating member. For example, the first sheath 50 and the second sheath 54 are formed by extruding resin around the first wiring 20, the second wiring 30, and the third wiring 40. The type of resin is not particularly limited, and examples thereof include polyvinyl chloride, polyolefin, and polyurethane.

The second sheath 54 may have a trace left by pulling out the first wiring 20. For example, as shown in FIG. 4, the interposed member 60 in the first sheath 50 has a pentagonal shape. As shown in FIG. 5, the interposed member 62 in the second sheath 54 may also have a pentagonal shape. In this case, an empty space S unnaturally remains inside two corner portions 63 of the interposed member 62. That is, the two corner portions 63 of the interposed member 62 have a corner shape despite there being the empty space S inside. Such corner portions 63 can be regarded as a trace left by pulling out the first wiring 20.

The plurality of wirings may be twisted within the sheaths. For example, five wire materials made up of two first coated electric wires 21, two second coated electric wires 31, and one cable 40 may extend spirally in the extending direction of the wiring member 10 while maintaining the pentagonal arrangement. In this case, the two corner portions 63 may extend spirally in the extending direction of the second sheath 54.

FIG. 6 is an end view showing a modification of the trace left by pulling out the first wiring 20.

As shown in FIG. 6, the second sheath 54 can have a force F that pushes the interposed member 62 and the plurality of wirings 30 and 40 radially inward. For example, during extrusion molding of the sheath, the temperature of the sheath decreases from a flowable temperature to room temperature. This temperature decrease may cause the sheath to contract, thereby generating the force F. The second sheath 54 may be slightly compressed relative to the first sheath 50 due to the force F. Specifically, in the parts corresponding to the second coated electric wires 31 and the cable 40, the second coated electric wires 31 and the cable 40 resist the force F. Meanwhile, since there is the space S inside the corner portions 63 without the first coated electric wires 21, if the parts of the interposed member 62 and the second sheath 54 located outside the corner portions 63 cannot fully resist the force F, the second sheath 54 may be compressed inward so as to fill the space S, as indicated by the imaginary lines in FIG. 6. At this time, the corner portions 63 of the interposed member 62 are also deformed.

In this case, the curvature of the parts of the outer surface of the second sheath 54 located outside the corner portions 63 differs from the curvature of the parts of the outer surface of the second sheath 54 located outside the second coated electric wires 31 and the cable 40. The parts of the outer surface of the second sheath 54 located outside the corner portions 63 are curvature change portions 57. Although the first sheath 50 may also be subjected to the force F, the first sheath 50 can resist the force F because the first coated electric wires 21 are present.

The wiring member 10 includes a first resin molded portion 70 and a second resin molded portion 80. The first resin molded portion 70 covers the first wiring 20, the second wiring 30, the third wiring 40, the first sheath 50, and the second sheath 54 in the first branch portion. The second resin molded portion 80 covers the second wiring 30, the third wiring 40, and the second sheath 54 in the second branch portion.

The first resin molded portion 70 holds the paths of the first segment, the second segment, and the first wiring 20 in the first branch portion. The first resin molded portion 70 has three extension ports 71, 72, and 73. The first segment extends out from the extension port 71, the second segment extends out from the extension port 72, and the first wiring 20 extends out from the extension port 73. Here, the first sheath 50 extends out from the extension port 71, the second sheath 54 extends out from the extension port 72, and the two first coated electric wires 21 extend out from the extension port 73. The path from the first branch portion to the extension port 73 is longer than the path from the first branch portion to the extension port 72.

Here, the first resin molded portion 70 is formed in a T-shape. The first resin molded portion 70 may be formed in a shape other than a T-shape. The first resin molded portion 70 has a planar shape. The three paths connecting the first branch portion and the three extension ports 71, 72, and 73 are parallel to one plane. The first resin molded portion 70 may have a three-dimensional shape.

A part of a fixing piece B is embedded in the first resin molded portion 70. The fixing piece B is, for example, a bracket. One end of the bracket is fixed to the outer periphery of the other end portion 52 of the first sheath 50. The first resin molded portion 70 also covers the one end of the bracket. The other end of the bracket extends out from the first resin molded portion 70. A vehicle fixing portion is provided at the other end of the bracket.

The wiring member 10 includes a third resin molded portion 90. The third resin molded portion 90 is provided at the one end portion 51 of the first sheath 50. A part of a fixing piece B is embedded in the third resin molded portion 90, as in the first resin molded portion 70. The fixing piece B is, for example, a bracket. One end of the bracket is fixed to the outer periphery of the first sheath 50. The third resin molded portion 90 also covers the one end of the bracket. The other end of the bracket extends out from the third resin molded portion 90. A vehicle fixing portion is provided at the other end of the bracket.

The second resin molded portion 80 holds the paths of the second segment, the second wiring 30, and the third wiring 40 in the second branch portion. The second resin molded portion 80 has three extension ports 81, 82, and 83. The second segment extends out from the extension port 81, the second wiring 30 extends out from the extension port 82, and the third wiring 40 extends out from the extension port 83. Here, the second sheath 54 extends out from the extension port 81, the two second coated electric wires 31 extend out from the extension port 82, and the one cable 40 extends out from the extension port 83. The path from the second branch portion to the extension port 82 is longer than the path from the second branch portion to the extension port 83.

Here, the second resin molded portion 80 is formed in a T-shape. The second resin molded portion 80 may be formed in a shape other than a T-shape. The second resin molded portion 80 has a planar shape. The three paths connecting the second branch portion and the three extension ports 81, 82, and 83 are parallel to one plane. The second resin molded portion 80 may have a three-dimensional shape.

The plurality of sheaths, the first resin molded portion 70, and the second resin molded portion 80 are formed of a urethane-based material. This enhances the adhesion between the first resin molded portion 70 and each of the first sheath 50 and the second sheath 54, and enhances the adhesion between the second resin molded portion 80 and the second sheath 54.

The wiring member 10 includes a first connector 11, a second connector 12, a third connector 13, and a sensor 14. One end of each of the first wiring 20, the second wiring 30, and the third wiring 40 is connected to the common first connector 11. The other end of the first wiring 20 is connected to the second connector 12. The other end of the second wiring 30 is connected to the third connector 13. The other end of the third wiring 40 is connected to the sensor 14. For example, the second connector 12 is connected to an active damper suspension (ADS). The ADS changes the resilient force by hydraulic pressure, pneumatic pressure, or the like. The third connector 13 is connected to an electric parking brake (EPB). The EPB restrains the rotation of the vehicle wheels after the vehicle has stopped. The sensor 14 is, for example, an anti-lock braking system (ABS) sensor. The ABS sensor measures the rotational speed of the vehicle wheels.

Here, the wiring member 10 includes a first connector cover 91, a second connector cover 92, and a third connector cover 93. The first connector cover 91 covers from the end of the first sheath 50 to the rear end of the first connector 11. The second connector cover 92 covers from the extension port 73 to the rear end of the second connector 12. The third connector cover 93 covers from the extension port 82 to the rear end of the third connector 13.

### Manufacturing Method

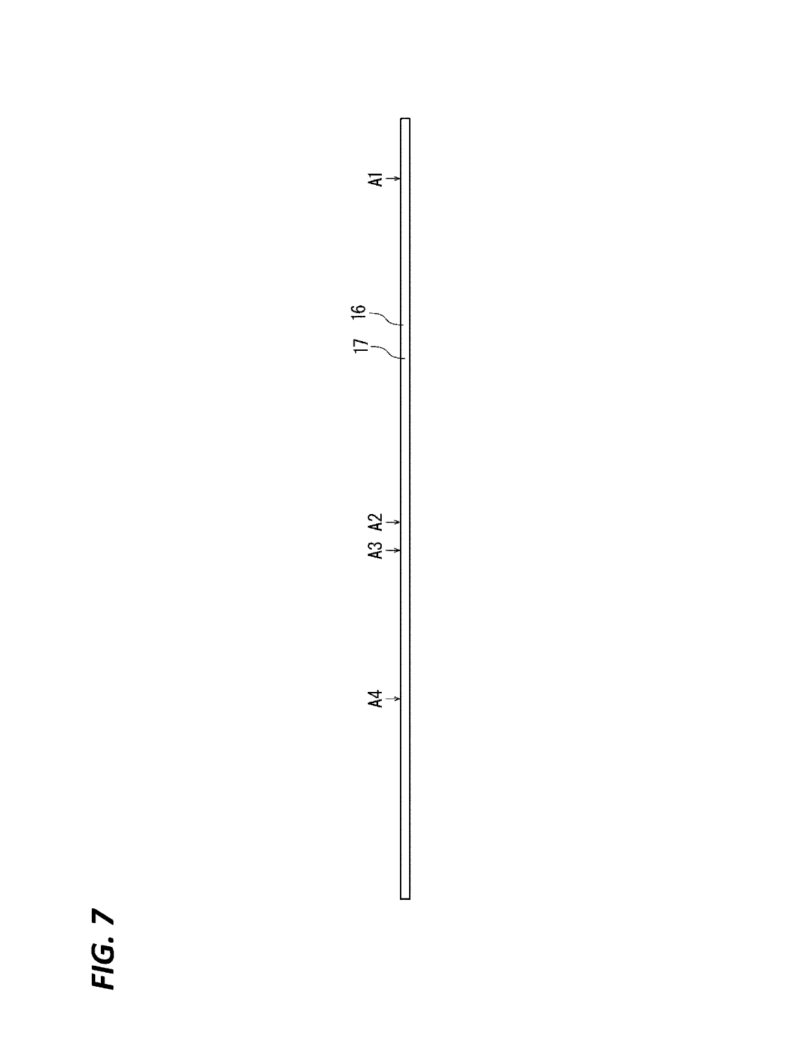

A manufacturing method for the wiring member 10 will be described with further reference to FIGS. 7 to 10. FIGS. 7 to 10 are plan views showing how the wiring member 10 is manufactured. The manufacturing method for the wiring member 10 includes a preparation step, a division step, and a branching step.

The preparation step is a step of preparing a cable 16 including a plurality of wirings and a sheath covering the plurality of wirings, as shown in FIG. 7. For example, the cable 16 is cut to a predetermined length from an elongated stock material. In the cable 16, a sheath 17 extends from one end to the other end. The first wiring 20, the second wiring 30, and the third wiring 40 extend inside the sheath 17 from one end to the other end of the sheath 17.

The division step is a step of cutting the sheath 17 to divide it into the first sheath 50 and the second sheath 54 at an intermediate portion of the cable 16. In FIG. 7, arrows A1 to A4 indicate locations where the sheath 17 is cut. Parts of the sheath 17 are stripped after cutting. Here, the sheath 17 is stripped in the segment from arrow A1 to one end (right end in FIG. 7) of the sheath 17, the segment between arrows A2 and A3, and the segment from arrow A4 to the other end (left end in FIG. 7) of the sheath 17.

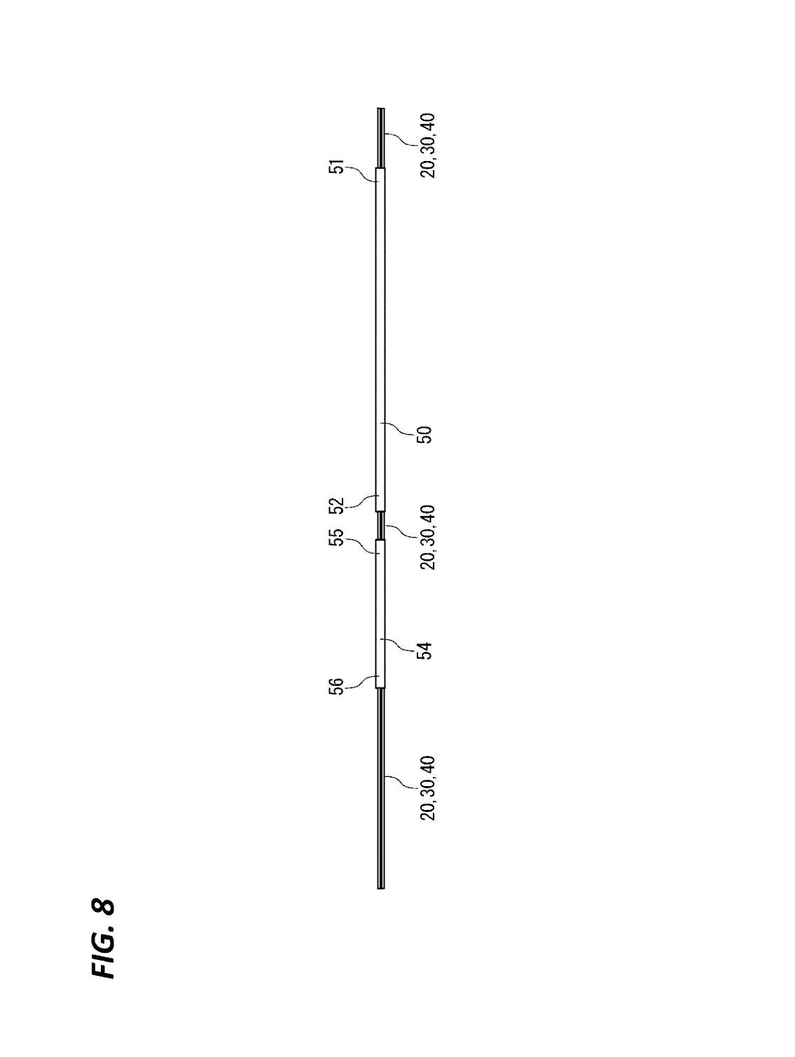

As shown in FIG. 8, the sheath in the segment between arrows A1 and A2 remains, forming the first sheath 50. The sheath in the segment between arrows A3 and A4 remains, forming the second sheath 54. In FIG. 8, the first wiring 20, the second wiring 30, and the third wiring 40 are exposed at the locations where the sheath 17 has been stripped.

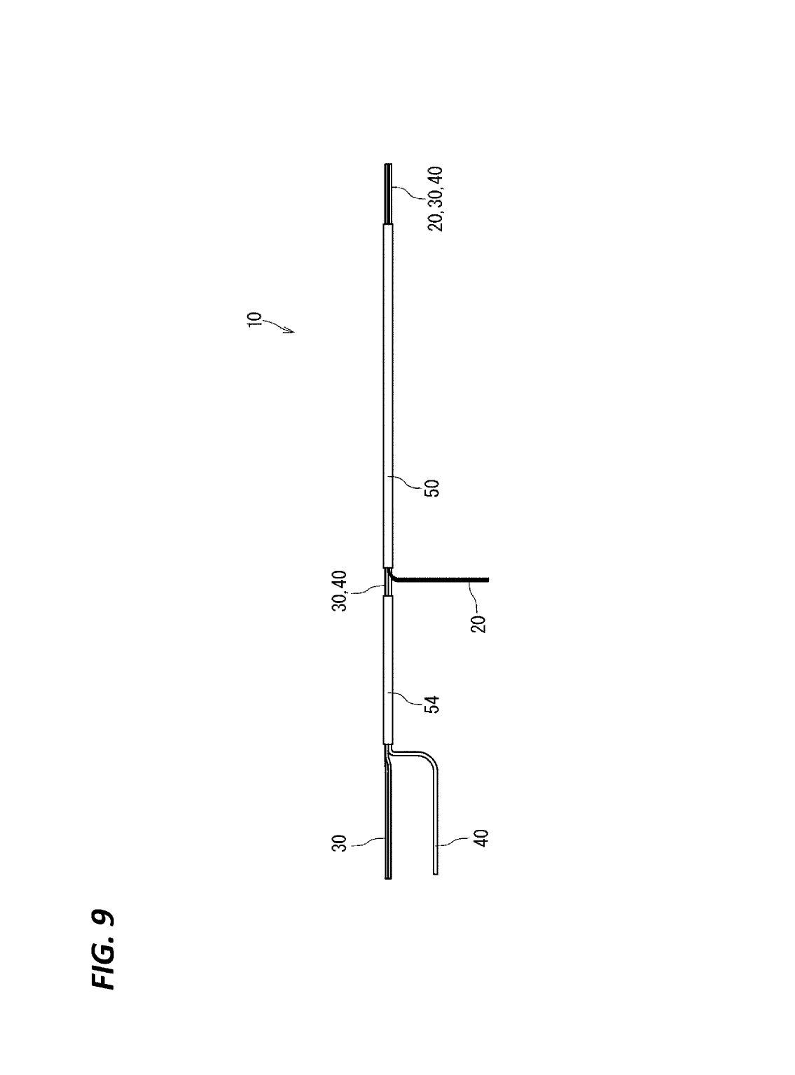

The branching step is a step of pulling the first wiring 20 out of the second sheath 54 and branching the first wiring 20 from the second wiring 30 between the first sheath 50 and the second sheath 54, as shown in FIG. 9. Here, the two first coated electric wires 21 are pulled out of the second sheath 54. During this, the presence of the interposed members 60 and 62 suppresses contact between the second sheath 54 and the first coated electric wires 21. This facilitates pulling the first coated electric wires 21 out of the second sheath 54. Moreover, since the first coated electric wires 21 are the smallest among the five wire materials in the sheath, the first coated electric wires 21 can be pulled out more easily with a smaller frictional force than the second coated electric wires 31 and the cable 40.

Here, the second sheath 54 does not have a slit along its entire length. The first coated electric wires 21 are pulled out of the end of the second sheath 54 on the first sheath 50 side. The second sheath 54 may have a slit along its entire length. Such a slit facilitates pulling out the first coated electric wires 21.

In FIG. 8, the length of the first coated electric wires 21 matches the length of the second coated electric wires 31 and the length of the cable 40. If the required length of the first coated electric wires 21 from the other end portion 52 of the first sheath 50 to the second connector 12 is shorter than the length of the second coated electric wires 31 and the length of the cable 40, the first coated electric wires 21 may be cut before being pulled out of the second sheath 54. This shortens the length of the first coated electric wires 21 to be pulled out of the second sheath 54. If the required length of the first coated electric wires 21 from the other end portion 52 of the first sheath 50 to the second connector 12 is shorter than the length from the other end portion 52 of the first sheath 50 to the other end portion 56 of the second sheath 54, the cutting position of the first coated electric wires 21 may be at the position of the other end portion 56 of the second sheath 54.

In FIG. 9, the first coated electric wires 21 are branched from the second coated electric wires 31 and the cable 40 between the first sheath 50 and the second sheath 54. Furthermore, the second coated electric wires 31 are branched from the cable 40 beyond the other end portion 56 of the second sheath 54.

The manufacturing method for the wiring member 10 includes a terminal connection step, a molding step, and a covering step.

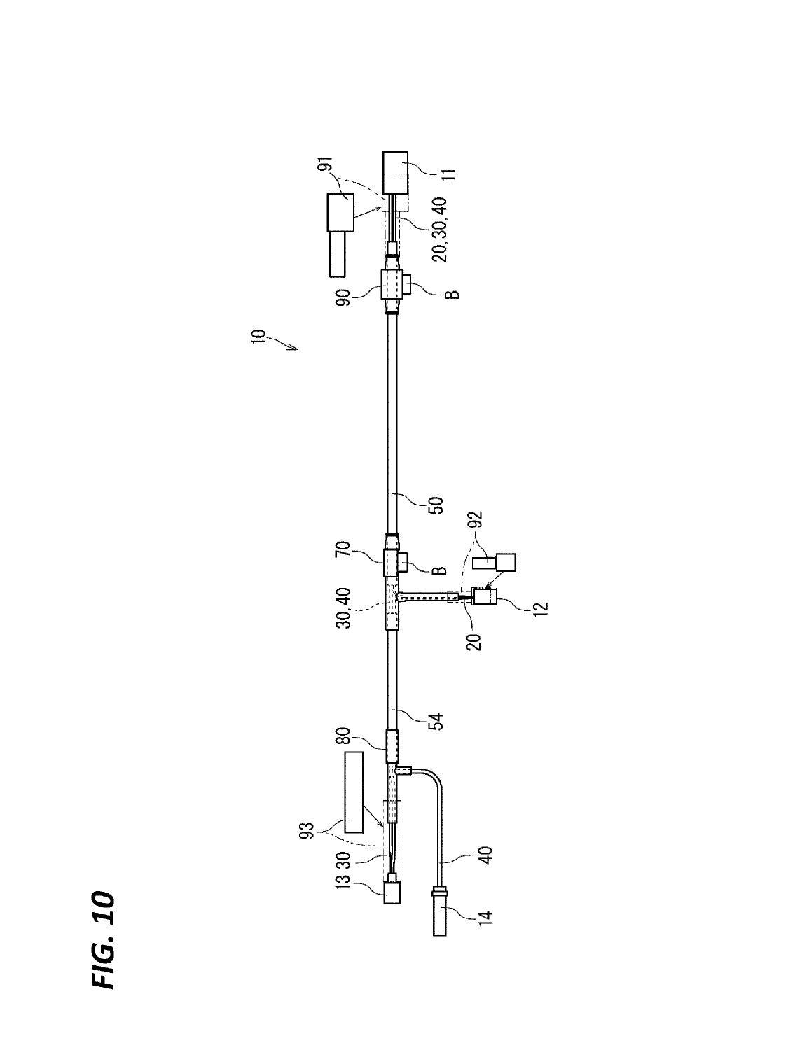

The terminal connection step is a step of connecting the ends of the first wiring 20, the second wiring 30, and the third wiring 40. As shown in FIG. 10, one end of each of the first wiring 20, the second wiring 30, and the third wiring 40 is connected to the first connector 11. The other end of the first wiring 20 is connected to the second connector 12. The other end of the second wiring 30 is connected to the third connector 13. The other end of the third wiring 40 is connected to the sensor 14.

The molding step is a step of forming the first resin molded portion 70 and the second resin molded portion 80, as shown in FIG. 10. Here, the third resin molded portion 90 is also formed.

In forming the first resin molded portion 70, the part from the other end portion 52 of the first sheath 50 to the one end portion 55 of the second sheath 54 and the first coated electric wires 21 extending out from the other end portion 52 of the first sheath 50 are placed in a first mold. Flowable resin is then poured into the first mold. This forms the first resin molded portion 70. Due to the heat of the flowable resin, the first sheath 50 and the second sheath 54 partially melt and adhere to the resin forming the first resin molded portion 70. Here, since the first resin molded portion 70, the first sheath 50, and the second sheath 54 are formed of a urethane-based material, the resin forming the first resin molded portion 70 integrates with the first sheath 50 and the second sheath 54.

In forming the second resin molded portion 80, the other end portion 56 of the second sheath 54 and the second coated electric wires 31 and the cable 40 extending out from the other end portion 56 of the second sheath 54 are placed in a second mold. Flowable resin is then poured into the second mold. This forms the second resin molded portion 80. Due to the heat of the flowable resin, the second sheath 54 partially melts and adheres to the resin forming the second resin molded portion 80. Here, since the second resin molded portion 80 and the second sheath 54 are formed of a urethane-based material, the resin forming the second resin molded portion 80 integrates with the second sheath 54.

The covering step is a step of attaching the first connector cover 91, the second connector cover 92, and the third connector cover 93. The terminal connection step, the molding step, and the covering step may be performed in any order. For example, after the molding step, the covers 91, 92, and 93 may be passed over the ends of the wires 20, 30, and 40 to be situated on the resin molded portion 70, 80, 90 side. Then, after the terminal connection step, the covers 91, 92, and 93 may be shifted and attached to the connectors 11, 12, and 13.

### Effects, etc.

With the wiring member 10 configured as described above, a part of the elongated sheath including the first sheath 50 and the second sheath 54 can be used as the first sheath 50 and another part of the elongated sheath can be used as the second sheath 54. This makes it unnecessary to provide another member such as a rubber hose instead of the sheath, thereby achieving cost reduction.

Moreover, the second wiring 30 and the third wiring 40 extend alongside each other inside the second sheath 54 in the second segment and branch at the second branch portion that extends out from an end of the second sheath 54. This allows the second sheath 54 to function as a protective material for the wirings between the first branch portion and the second branch portion.

Moreover, the wiring member 10 includes the first resin molded portion 70 and the second resin molded portion 80. Since the materials of the first sheath 50 and the second sheath 54 are the same, it is easy to select compatible materials for the first resin molded portion 70, the first sheath 50, and the second sheath 54. Moreover, by using the same material for the second resin molded portion 80 as for the first resin molded portion 70, it is easy to select compatible materials for the second resin molded portion 80 and the second sheath 54.

Moreover, the plurality of sheaths, the first resin molded portion 70, and the second resin molded portion 80 are formed of a urethane-based material. This enhances the adhesion between the resin molded portions and the sheaths, and enhances the watertightness between the resin molded portions and the sheaths.

Moreover, the second sheath 54 has a trace left by pulling out the first wiring 20. This makes it easy to determine that the original single sheath of the cable 16 has been divided into the first sheath 50 and the second sheath 54.

Moreover, a manufacturing method for the wiring member 10 includes: a step of cutting the sheath to divide the sheath into the first sheath 50 and the second sheath 54 at an intermediate portion of the cable 16; and a step of pulling the first wiring 20 out of the second sheath 54 to branch the first wiring 20 from the second wiring 30 between the first sheath 50 and the second sheath 54. Thus, a part of the original sheath of the cable 16 can be used as the first sheath 50 and another part of the sheath can be used as the second sheath 54. This makes it unnecessary to provide another member such as a rubber hose instead of the second sheath 54, thereby achieving cost reduction.

### Supplementary Notes

Although the description above assumes that the resin molded portions 70 and 80 are provided, this is not an essential configuration. The resin molded portions 70 and 80 may be omitted. The shape of each branch portion may be maintained by tape, protectors, etc.

Although the wiring member 10 has been described as having six cores, this is not an essential configuration. The wiring member 10 may have, for example, eight cores. The first wiring 20, the second wiring 30, or the third wiring 40 may have three or more cores. The wiring member 10 may include a fourth wiring that branches from the first wiring 20, the second wiring 30, and the third wiring 40. In this case, the branch position of the fourth wiring may be set as appropriate.

The configurations described in the above embodiments and modifications may be combined as appropriate as long as they are not mutually contradictory.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A wiring member comprising:
a plurality of wirings including a first wiring and a second wiring; and
a plurality of sheaths covering at least part of the plurality of wirings,
wherein the second wiring extends alongside the first wiring in a first segment and branches from the first wiring at a first branch portion,
the plurality of sheaths include a first sheath covering the first wiring and the second wiring in the first segment, and a second sheath covering the second wiring in a second segment after the first branch portion, and
the first sheath and the second sheath are coating members of a same type that are formed of a same material.

2. The wiring member according to claim 1, wherein the plurality of wirings include a third wiring extending alongside the first wiring and the second wiring inside the first sheath in the first segment, and
the second wiring and the third wiring extend alongside each other inside the second sheath in the second segment and branch at a second branch portion that extends out from an end of the second sheath.

3. The wiring member according to claim 2, comprising:
a first resin molded portion covering the first wiring, the second wiring, the third wiring, the first sheath, and the second sheath in the first branch portion; and
a second resin molded portion covering the second wiring, the third wiring, and the second sheath in the second branch portion.

4. The wiring member according to claim 3, wherein the plurality of sheaths, the first resin molded portion, and the second resin molded portion are formed of a urethane-based material.

5. The wiring member according to claim 1, comprising a resin molded portion covering the first wiring, the second wiring, the first sheath, and the second sheath in the first branch portion.

6. The wiring member according to claim 1, wherein the second sheath has a trace left by pulling out the first wiring.

7. A manufacturing method for a wiring member, comprising:
a step of preparing a cable that includes a plurality of wirings including a first wiring and a second wiring and a sheath covering the plurality of wirings;
a step of cutting the sheath to divide the sheath into a first sheath and a second sheath at an intermediate portion of the cable; and
a step of pulling the first wiring out of the second sheath to branch the first wiring from the second wiring between the first sheath and the second sheath.
